(19) United States
(12) Patent Application Publication
(10) Pub. No.: US 2015/0089518 A1
(43) Pub. Date: Mar. 26, 2015

(54) INFORMATION PROVIDING APPARATUS, INFORMATION PROVIDING METHOD AND NON-TRANSITORY COMPUTER READABLE RECORDING MEDIUM FOR RECORDING AN INFORMATION PROVIDING PROGRAM

(71) Applicant: Kabushiki Kaisha Toshiba, Tokyo (JP)

(72) Inventors: Kenji Yamada, Tokyo (JP); Yukie Takahashi, Tokyo (JP); Yoshikata Tobita, Tokyo (JP); Yoshiyasu Itoh, Tokyo (JP)

(73) Assignee: Kabushiki Kaisha Toshiba, Tokyo (JP)

(21) Appl. No.: 14/133,152

(22) Filed: Dec. 18, 2013

(30) Foreign Application Priority Data
Sep. 25, 2013 (JP) 2013-198882

(51) Int. Cl. H04N 21/442; H04N 21/8405; H04N 21/44

(52) U.S. Cl. CPC H04N 21/44218; H04N 21/44008; H04N 21/8405
USPC 725/10

(57) ABSTRACT

According to one embodiment, an information providing apparatus has a receiver, an input and a processor. The receiver is configured to receive area information, program information and subtitle information, the area information regarding a broadcast area of programs and corresponding to an area designated by a user, the program information regarding the programs, the subtitle information regarding subtitles included in the programs. The input is configured to input a first keyword. The processor is configured to search the first keyword from the subtitle information, and to generate attention information regarding at least one of an attention program by using a search result of the first keyword from the subtitle information, the programs broadcast in the designated area.

### CROSS REFERENCE TO RELATED APPLICATIONS

This application is based upon and claims the benefit of priority from the prior Japanese Patent Application No. 2013-198882, filed on Sep. 25, 2013, the entire contents of which are incorporated herein by reference.

### FIELD

Embodiments described herein relate generally to an information providing apparatus, an information providing method, and a non-transitory computer readable recording medium for recording an information providing program.

### BACKGROUND

As the Internet and smartphones have become more popular, a variety of information can be obtained more easily than in the past. The information obtained is, however, often common nationwide, and obtaining area-specific information is rather difficult at present.

### BRIEF DESCRIPTION OF THE DRAWINGS

FIG. 1 is a block diagram schematically showing a structure of an information providing system.

FIG. 2 is a block diagram schematically showing a structure of the TV broadcast reception apparatus 1.

FIG. 3 is a block diagram schematically showing a structure of the TV broadcast display apparatus 2.

FIG. 4 is a block diagram schematically showing a structure of the collecting apparatus 4.

FIG. 5 is a diagram explaining the process performed by the collection module 44.

FIG. 6 is a diagram explaining the process performed by the degree-of-attention evaluator 45.

FIG. 7 is a diagram explaining the process performed by the keyword extractor 46.

FIG. 8 is a diagram showing an example of the database structure.

FIG. 9 is a block diagram schematically showing a structure of the user terminal 5.

FIG. 10 is a diagram explaining the attention information.

FIG. 11 is a sequence diagram showing an example of a process performed by an information providing system.

### DETAILED DESCRIPTION

In general, according to one embodiment, an information providing apparatus has a receiver, an input and a processor. The receiver is configured to receive area information, program information and subtitle information, the area information regarding a broadcast area of programs and corresponding to an area designated by a user, the program information regarding the programs, the subtitle information regarding subtitles included in the programs. The input is configured to input a first keyword. The processor is configured to search the first keyword from the subtitle information, and to generate attention information regarding at least one of an attention program by using a search result of the first keyword from the subtitle information, the programs broadcast in the designated area

Hereinafter, an embodiment will be specifically described with reference to the accompanying diagrams.

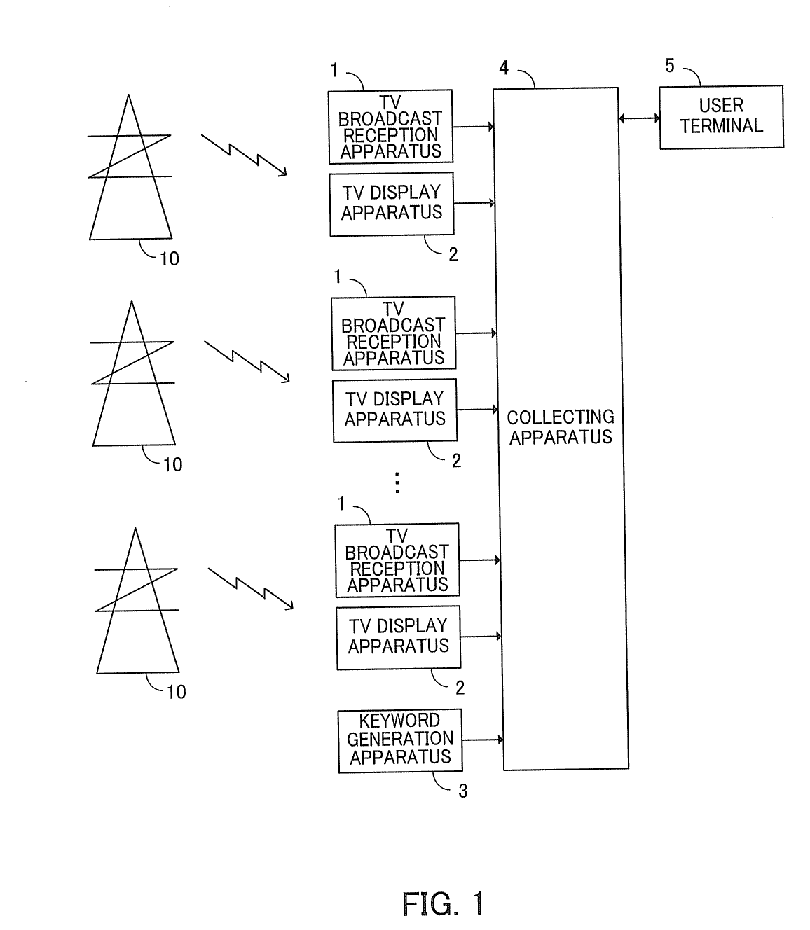

FIG. 1 is a block diagram schematically showing a structure of an information providing system. The information providing system includes a plurality of TV (TV) broadcast reception apparatus 1, a plurality of TV display apparatus 2, a keyword generation apparatus 3, a collecting apparatus (information providing apparatus) 4, and a user terminal 5.

The TV broadcast reception apparatuses 1 are each provided to a different area, and receives TV broadcast waves from a different TV broadcast station 10. If, for example, there are 30 TV broadcast stations 10 nationwide, 30 TV broadcast reception apparatuses 1 each corresponding to a different TV station 10 are preferably provided.

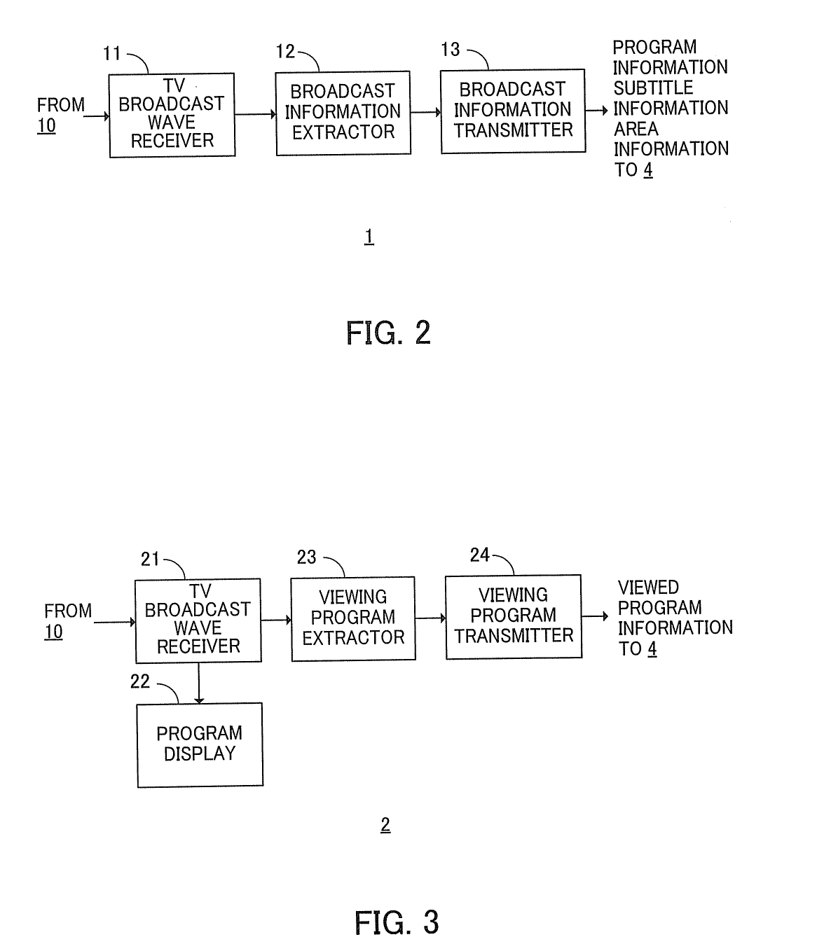

FIG. 2 is a block diagram schematically showing a structure of the TV broadcast reception apparatus 1. As shown in FIG. 2, each TV broadcast reception apparatus 1 includes a TV broadcast wave receiver 11, a broadcast information extractor 12, and a broadcast information transmitter 13.

The TV broadcast wave receiver 11 receives TV broadcast waves from the TV broadcast station 10 in the area where the TV broadcast wave receiver 11 itself is provided. The broadcast waves include a plurality of programs (contents).

The broadcast information extractor 12 extracts broadcast information such as program information indicating each program included in the received TV broadcast waves, and subtitle information indicating subtitles included in each program. The program information is information which specifies the program, and is, for example, the title of the program. The program information is extracted from, for example, an electronic program guide. The subtitle information can be included in the TV broadcast waves, or extracted from video information of the program.

The broadcast information transmitter 13 transmits, to the collecting apparatus 4 through the Internet, for example, the program information, the subtitle information, and area information, the area information indicating the area where the broadcast information transmitter 13 itself is provided, in the other word, area information indicating the broadcast area of the received program.

Referring back to FIG. 1, the TV broadcast display apparatus 2 is a so-called “TV” located in each household, for example. For one TV broadcast reception apparatus 1, one or more TV display apparatus 2 are provided to receive TV broadcast waves from the TV broadcast station 10 in the same area. The number of TV display apparatus 2 is not limited, but as large number as possible is preferable in order to improve the accuracy of the degree of attention, which will be described later.

FIG. 3 is a block diagram schematically showing a structure of the TV broadcast display apparatus 2. As shown in FIG. 3, the TV broadcast display apparatus 2 includes a TV broadcast wave receiver 21, a program display 2, a viewing program extractor 23, and a viewing program transmitter 24.

The TV broadcast wave receiver 21 receives TV broadcast waves from the TV broadcast station 10 in the corresponding area. In response to an instruction from a user, the TV broadcast wave receiver 21 selects (tunes) a specific program of a plurality of programs included in the TV broadcast waves. One or more programs can be selected.

The program display 2 is a display such as a liquid crystal panel display to display the selected program(s). The TV broadcast wave receiver 21 may extract only one program, and the program display 2 may display this program. Alternatively, if the program display 2 has a dual screen display function, the TV broadcast wave receiver 21 may select two programs, and the program display 2 may display the two programs at the same time.

The viewing program extractor 23 extracts program information indicating the program viewed by the user. The TV broadcast display apparatus 2 preferably includes a camera to confirm the program actually viewed by the user, but the program displayed on the program display 2 may be regarded as the program viewed by the user.

The viewing program transmitter 24 transmits viewed program information indicating the program viewed by the user to the collecting apparatus 4 through, for example, the Internet.

Referring back to FIG. 1, the keyword generation apparatus 3 generates keywords currently attracting attention (hereinafter simply referred to as “attention keywords”). The way of generating the attention keywords is not limited to a specific way. For example, keywords that are retrieved by a specific searching engine, or keywords that are often used in a social networking service (SNS) may be selected as the attention keywords. The selected attention keywords are transmitted to the collecting apparatus 4 through, for example, the Internet.

The collecting apparatus 4 collects information from the TV broadcast reception apparatus 1, the TV broadcast display apparatus 2, and the keyword generation apparatus 3, and creates a database for indicating the attention keywords for each area. The collecting apparatus 4 then provides area-based attention keywords to the user terminal 5.

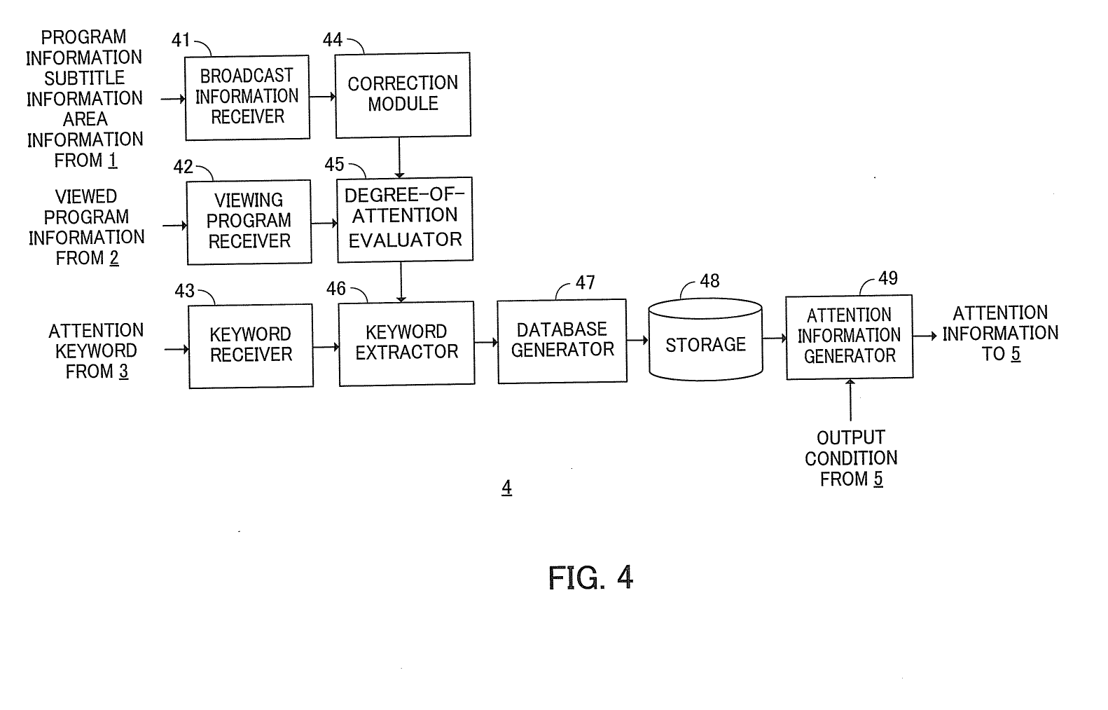

FIG. 4 is a block diagram schematically showing a structure of the collecting apparatus 4. As shown in FIG. 4, the collecting apparatus 4 includes a broadcast information receiver 41, a viewing program receiver 42, a keyword receiver 43, a collection module 44, a degree-of-attention evaluator 45, a keyword extractor 46, a database generator 47, a storage 48, and an attention information generator 49. Although the respective units seem to be within a single apparatus in FIG. 4, they may be divided into two or more apparatuses, or may have a so-called “cloud computing” structure by which at least portions of the respective units are connected with each other via the Internet.

The broadcast information receiver 41 receives program information, subtitle information, and area information from the respective TV broadcast reception apparatus 1. The viewing program receiver 42 receives viewed program information indicating the programs viewed by the users from the respective TV display apparatus 2. The keyword receiver 43 receives the attention keywords from the keyword generation apparatus 3.

The collection module 44 acquires the program information, the subtitle information, and the area information from the broadcast information receiver 41, and associates with each other the program information, the area information indicating the area in which the program indicated by the program information is broadcast, and the subtitle information indicating the subtitles included in the program.

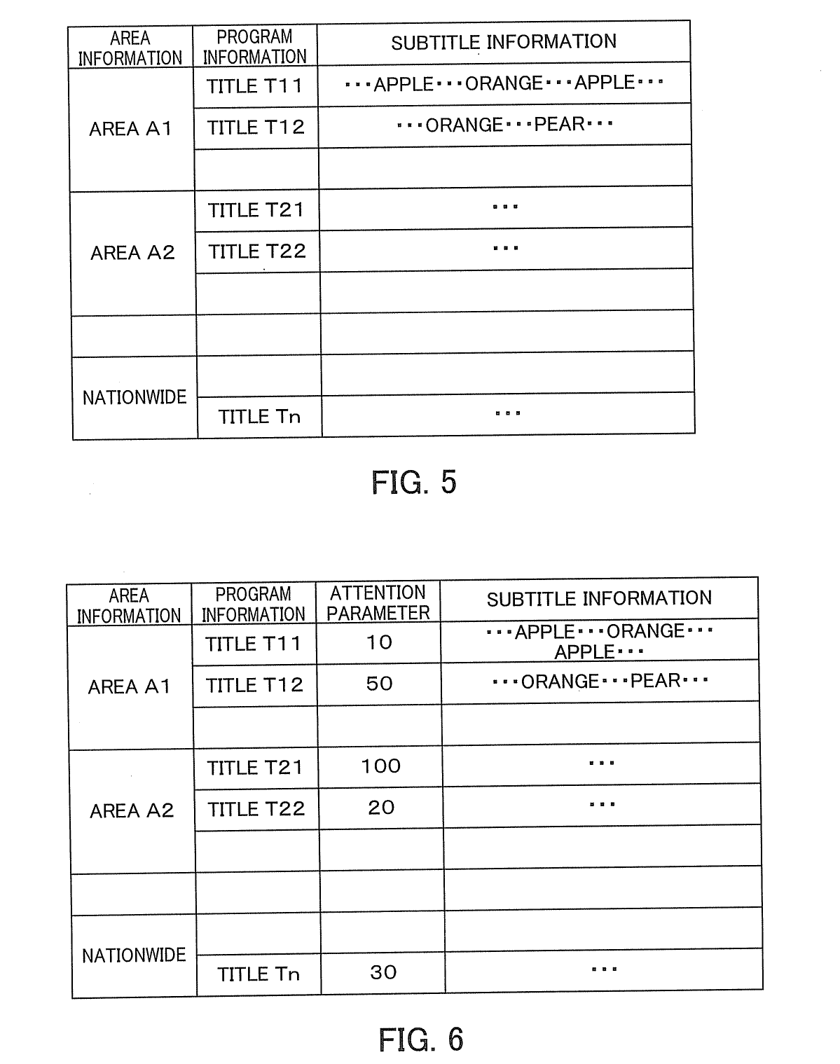

FIG. 5 is a diagram explaining the process performed by the collection module 44. As shown in FIG. 5, the collection module 44 classifies the program information based on areas. Specifically, the collection module 44 classifies the program information into those broadcast only in specific areas (so-called “local programs”) and those commonly broadcast in all the areas in which the TV broadcast reception apparatus 1 are provided (so-called “nationally-broadcast programs”). In the example shown in FIG. 5, programs Title T11 and Title T12 are broadcast only in Area A1. A program Title Tn is broadcast nationally. The subtitle information included in each program is associated with the corresponding program information.

Referring back to FIG. 4, the degree-of-attention evaluator 45 acquires the viewed program information from the viewing program receiver 42, and evaluates the degree of attention of each item of the program information based on the viewed program information.

FIG. 6 is a diagram explaining the process performed by the degree-of-attention evaluator 45. As shown in FIG. 6, the degree-of-attention evaluator 45 adds a degree of attention to each item of the program information collected by the collection module 44. The degree of attention is set such that a program viewed by many users has a high degree. For example, the number of TV display apparatus 2, the program displayed on which is viewed, may be regarded as an indicator of the degree of attention. In the example shown in FIG. 6, the degree of attention of Title T11 is 10 while the degree of attention of Title T12 is 50. This means that, in Area A1, the latter is attracting more attention.

Referring back to FIG. 4, the keyword extractor 46 acquires attention keywords from the keyword receiver 43, and extracts attention keywords included in the subtitle information collected by the collection module 44.

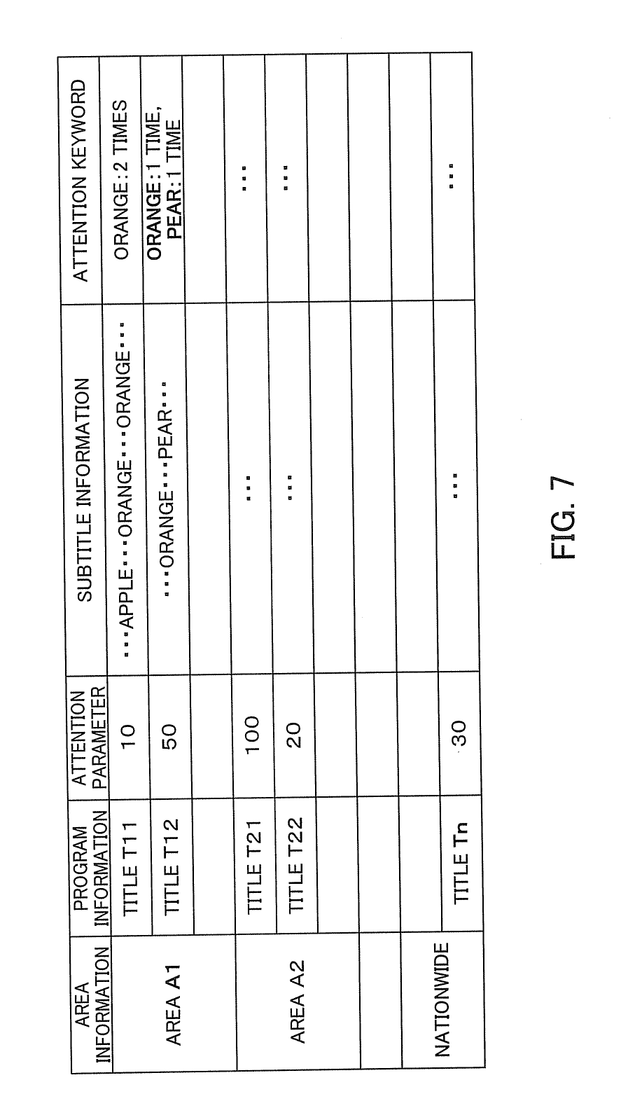

FIG. 7 is a diagram explaining the process performed by the keyword extractor 46. The keyword extractor 46 extracts the attention keywords from the subtitle information included in the program information. The keyword extractor 46 may count the number of appearance of the attention keywords. In FIG. 7, the words “orange” and “pear” are received as attention keywords. In this case, the keyword extractor 46 extracts that the attention keyword “orange” appears twice in the subtitle information included in the program information of Title T11. Similarly, the keyword extractor 46 extracts that the attention keywords “orange” and “pear” each appear once in the subtitle information included in the program information of Title T12.

Referring back to FIG. 4, the database generator 47 generates a database by retrieving important information from the information items shown in FIG. 7. The generated database is stored in the storage 48.

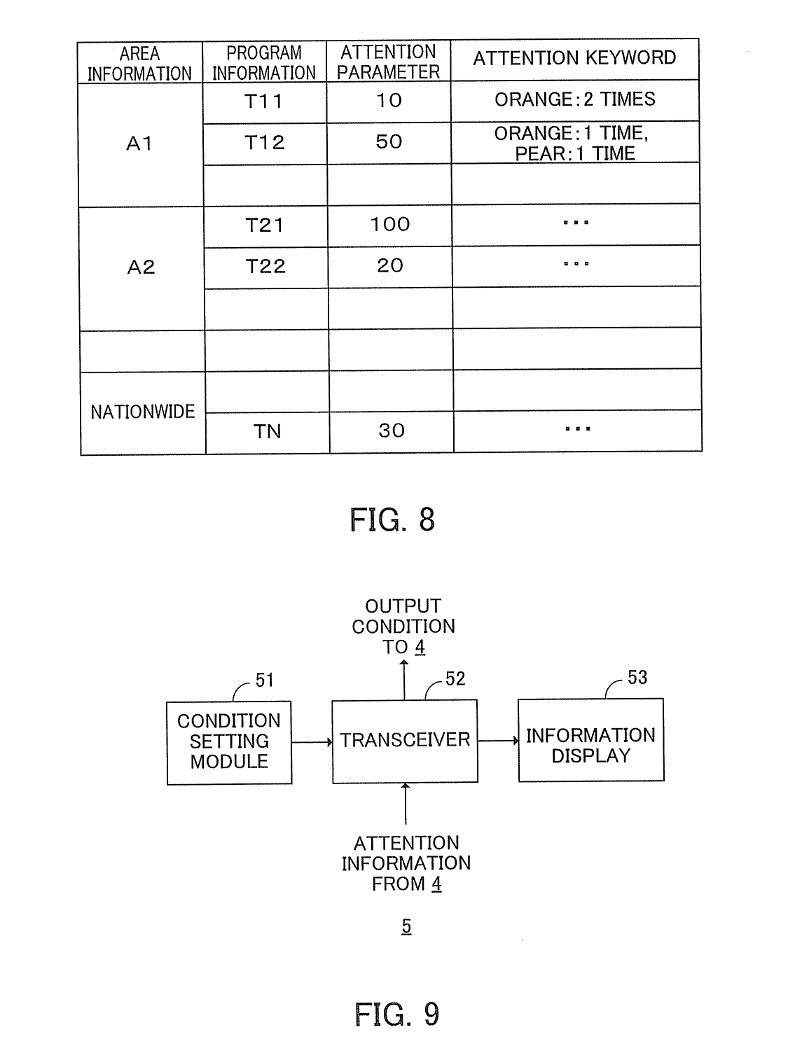

FIG. 8 is a diagram showing an example of the database structure. As shown in FIG. 8, the database includes program information indicating programs broadcast in the respective areas, the degrees of attention of the programs, and the attention keywords in the subtitle information contained in the program information of the programs, and the numbers of respective attention keywords.

Referring back to FIG. 4, the attention information generator 49 generates attention information in response to a request from the user terminal 5. More specifically, the attention information generator 49 receives an output condition from the user terminal 5 to generate the attention information in accordance with the output conditions, by referring to the database stored in the storage 48. The output conditions at least include designation of areas. Specific examples of the output conditions and the attention information will be described later.

Referring back to FIG. 1, the user terminal 5 is used by a user, and is configured to transmit the output conditions to the collecting apparatus 4 to request that information be supplied, and to receive the requested information. The user terminal 5 can be, for example, a single personal computer.

FIG. 9 is a block diagram schematically showing a structure of the user terminal 5. The user terminal 5 includes a condition setting module 51, a transceiver 52, and an information display 53.

The condition setting module 51 receives an instruction from the user via an interface such as a keyboard or mouse, and sets the output conditions described above.

The transceiver 52 transmits information to and receives information from the collecting apparatus 4 via, for example, the Internet. More specifically, the transceiver 52 transmits the output conditions to the collecting apparatus 4, and receives attention information from the collecting apparatus 4.

The information display 53 is a display such as a liquid crystal panel display, and displays the attention information.

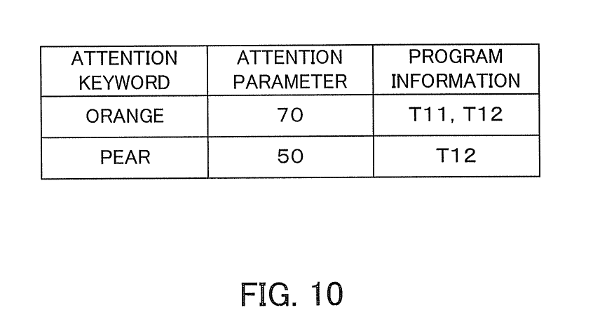

FIG. 10 is a diagram explaining the attention information. The output conditions for generating the attention information at least include designation of areas, such as designation of one or more specific areas, and designation of “all areas.” The attention information generator 49 of the collecting apparatus 4 refers to the database shown in FIG. 8, which is stored in the storage 48, to list the attention keywords included in the programs broadcast in the designated areas. The attention information generator 49 may newly calculate the degrees of attention of the respective attention keywords (second degrees of attention) based on the degrees of attention in the database (first degrees of attention), and may identify the program information of the program in which the attention keywords appear.

FIG. 10 shows an example where the condition setting module 51 of the user terminal 5 designates “Area A1” as the output condition. In this case, the attention information generator 49 of the collecting apparatus 4 lists the attention keywords “orange” and “pear” in the programs broadcast in Area A1, by referring to the database shown in FIG. 8, which is stored in the storage 48.

The word “orange” appears twice in the program Title T11 that has the score 10 in the degree of attention, and appears once in the program T12 that has the score 50 in the degree of attention. Thus, the attention information generator 49 can set the degree of attention of the word “orange” to be 10*2+50*1=70. Similarly, the attention information generator 49 can set the degree of attention of the word “pear” to be 50. Of course, the way of calculating the degree of attention is not limited to this way.

The attention information generator 49 may also identify that the word “orange” appears in the programs Title T11 and Title T12, and that the word “pear” appears in the program Title T12.

The attention information shown in FIG. 10 is transmitted from the attention information generator 49 to the user terminal 5, and displayed on the information display 53.

Incidentally, the output conditions can be set in various ways. For example, the number of the attention keywords listed can be limited. Furthermore, the degree of attention and the program information can be omitted, and only the attention keywords can be regarded as the attention information. If the degree of attention is omitted, the viewing program receiver 42 and the degree-of-attention evaluator 45 are not needed in the collecting apparatus 4.

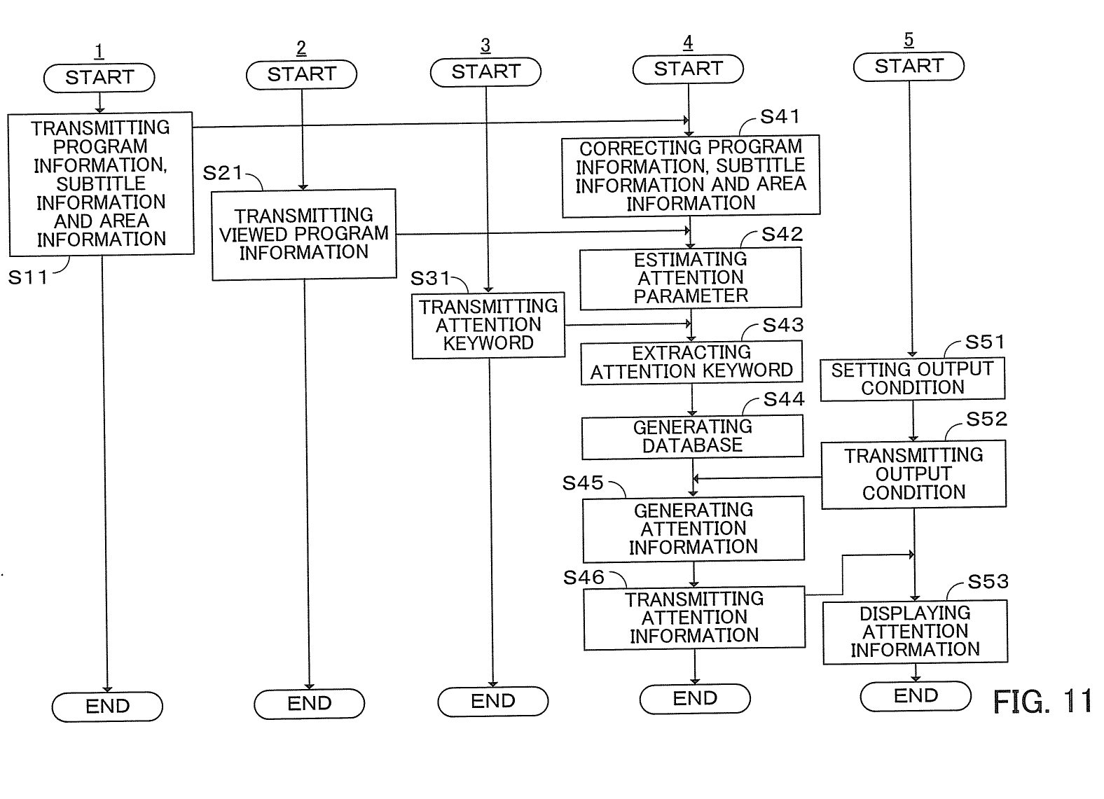

FIG. 11 is a sequence diagram showing an example of a process performed by an information providing system.

Each TV broadcast reception apparatus 1 transmits program information, subtitle information, and area information to the collecting apparatus 4 (step S11). Each TV broadcast display apparatus 2 transmits viewed program information to the collecting apparatus 4 (step S21). The keyword generation apparatus 3 transmits attention keywords to the collecting apparatus 4 (step S31). The steps S11, S21, and S31 are not necessarily performed in this order.

The broadcast information receiver 41 of the collecting apparatus 4 receives the program information, the subtitle information, and the area information. The collection module 44 then collects the program information, the subtitle information, and the area information (step S41, FIG. 5).

The viewing program receiver 42 receives the viewed program information. The degree-of-attention evaluator 45 evaluates the degree of attention of the program information based on the viewed program information (step S42, FIG. 6).

The keyword receiver 43 receives attention keywords. The keyword extractor 46 extracts the attention keywords from the subtitle information associated with the program information (step S43, FIG. 7).

The database generator 47 generates the database shown in FIG. 8, which is stored in the storage 48 (step S44).

The condition setting module 51 of the user terminal 5 sets output conditions based on an instruction from the user (step S51). The transceiver 52 transmits the output conditions to the collecting apparatus 4 (step S52).

In response thereto, the attention information generator 49 of the collecting apparatus 4 generates attention information in accordance with the output conditions (step S45). The attention information is transmitted to the user terminal 5 (step S46).

The transceiver 52 of the user terminal 5 receives the attention information, which is displayed on the information display 53 as shown in FIG. 10 (step S53).

As stated above, in the embodiment, a plurality of TV broadcast reception apparatuses 1 are provided, program information and subtitle information are collected area by area, and attention keywords are extracted from subtitle information included in respective programs. Accordingly, the user can know attention information specific to the corresponding area.

At least a part of the information providing system explained in the above embodiments can be formed of hardware or software. When the information providing system is partially formed of the software, it is possible to store a program implementing at least a partial function of the information providing system in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the information providing system can be distributed through a communication line (including radio communication) such as the Internet etc. Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. An information providing apparatus comprising:
a receiver configured to receive area information, program information and subtitle information, the area information regarding a broadcast area of programs and corresponding to an area designated by a user, the program information regarding the programs, the subtitle information regarding subtitles included in the programs;
an input configured to input a first keyword; and
a processor configured to search the first keyword from the subtitle information, and to generate attention information regarding at least one of an attention program by using a search result of the first keyword from the subtitle information, the programs broadcast in the designated area.

2. The apparatus of claim 1, wherein the processor is configured to classify items of the program information into programs broadcast in a specific area, and programs commonly broadcast in areas in which the TV broadcast receiver is provided.

3. The apparatus of claim 1, wherein the processor is configured to
add a first degree of attention to each program, and
calculate a second degree of attention based on the first degree of attention added to each program for the first keyword, and to generate the attention information comprising the first keyword and the second degree of attention.

4. The apparatus of claim 3, wherein the processor is configured to
count a number of appearance of the first keyword in the subtitle information, and
calculate the second degree of attention for the first keyword based on the first degree of attention added to each program, and the number of appearance of the first keyword.

5. The apparatus of claim 3, further comprising a viewing program receiver configured to receive viewed program information regarding a viewed program, wherein
the processor is configured to add the first degree of attention in accordance with the viewed program information.

6. The apparatus of claim 1, wherein the attention information comprises the program information comprising the first keyword.

7. An information providing method comprising:
receiving area information, program information and subtitle information, the area information regarding a broadcast area of programs and corresponding to an area designated by a user, the program information regarding the programs, the subtitle information regarding subtitles included in the programs;
inputting a first keyword; and
searching the first keyword from the subtitle information, and generating attention information regarding at least one of an attention program by using a search result of the first keyword from the subtitle information, the programs broadcast in the designated area.

8. The method of claim 7, further comprising classifying items of the program information into programs broadcast in a specific area, and programs commonly broadcast in areas in which the TV broadcast receiver is provided.

9. The method of claim 7, further comprising adding a first degree of attention to each program, wherein
upon generating the attention information, a second degree of attention is calculated based on the first degree of attention added to each program for the first keyword, and the attention information comprising the first keyword and the second degree of attention is generated.

10. The method of claim 9, further comprising:
counting a number of appearance of the first keyword in the subtitle information; and
calculating the second degree of attention for the first keyword based on the first degree of attention added to each program, and the number of appearance of the first keyword.

11. The method of claim 9, further comprising receiving viewed program information regarding a viewed program, wherein
upon adding the first degree of attention, the first degree of attention is added in accordance with the viewed program information.

12. The method of claim 7, wherein the attention information comprises the program information comprising the first keyword.

13. A non-transitory computer readable recording medium for recording an information providing program to cause a computer to execute:
receiving area information, program information and subtitle information, the area information regarding a broadcast area of programs and corresponding to an area designated by a user, the program information regarding the programs, the subtitle information regarding subtitles included in the programs;
inputting a first keyword; and
searching the first keyword from the subtitle information, and generating attention information regarding at least one of an attention program by using a search result of the first keyword from the subtitle information, the programs broadcast in the designated area.

14. The medium of claim 13, wherein the information providing program causes the computer to further execute classifying items of the program information are classified into programs broadcast in a specific area, and programs commonly broadcast in areas in which the TV broadcast receiver is provided.

15. The medium of claim 13, wherein the information providing program causes the computer to further execute adding a first degree of attention to each program, wherein
upon generating the attention information, a second degree of attention is calculated based on the first degree of attention added to each program for the first keyword, and the attention information comprising the first keyword and the second degree of attention is generated.

16. The medium of claim 15, wherein the information providing program causes the computer to further execute:
counting a number of appearance of the first keyword in the subtitle information; and
calculating the second degree of attention for the first keyword based on the first degree of attention added to each program, and the number of appearance of the first keyword.

17. The medium of claim 15, wherein the information providing program cause the computer to further execute receiving viewed program information regarding a viewed program, wherein
upon adding the first degree of attention, the first degree of attention is added in accordance with the viewed program information.

18. The medium of claim 13, wherein the attention information comprises the program information comprising the first keyword.
